(19) United States
(12) Patent Application Publication
(10) Pub. No.: US 2006/0267506 A1
(43) Pub. Date: Nov. 30, 2006

(54) Image display device

(76) Inventors: Junichi Satoh, Kamakura (JP); Fumio Haruna, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,445

(22) Filed: Mar. 6, 2006

(30) Foreign Application Priority Data
May 31, 2005 (JP) 2005-159262

(51) Int. Cl. H05B 39/00

(52) U.S. Cl. 315/161

(57) ABSTRACT

An image display device according to the present invention has: a cathode plate on which plural electron emission elements for emitting electrons are provided; an anode plate having phosphors and a metal back, the plate being disposed facing the cathode plate; spacers for supporting the cathode plate and the anode plate; a high-voltage control circuit for controlling high voltage between respective two ends of the spacers. In a video signal detection circuit, at least one of features of the inputted video signal, for example, average amplitude, maximum amplitude, a horizontal synchronizing signal, or a vertical synchronizing signal is detected, and when a result of the detection meets a predetermined condition, the high voltage applied to the two ends of the spacers is decreased, thereby the current flowing into the spacers is decreased.

### CLAIM OF PRIORITY

The present application claims priority from Japanese application Serial No. JP 2005-159262, filed on May 31, 2005, the content of which is hereby incorporated by reference into this application.

### BACKGROUND OF THE INVENTION

1. Field of the Invention

The present invention relates to an image display device such as a field or electron emission display (FED), and in particular, relates to reduction in power consumption during driving FED.

2. Description of the Related Art

FIG. 1 is a view showing an example of an internal structure of an FED panel. The related art on FED is described using FIG. 1.

The FED has a cathode substrate 11 on which plural electron emission elements 100 are provided, and an anode substrate 15 including phosphors 17, which is disposed facing the cathode substrate. The electron emission elements 100 are bonded to scan lines 51 via connection electrodes 28, and furthermore connected to signal lines 41. Voltage is applied between the scan lines 51 and the signal lines 41, thereby electrons 26 are emitted from the electron emission elements 100, and then the electrons 26 excite the phosphors 17, causing luminescence of the phosphors 17 due to excitation, and consequently images are formed.

In the FED configured as above, it is necessary to evacuate gas from a space between the cathode substrate 11 and the anode substrate 15 and keep the space at high vacuum for improving electron emission operation of the electron emission elements 100 and increasing the life of the electron emission elements 100. Therefore, structure supporters 12 (hereinafter, called spacers 12) are typically disposed for bearing the atmospheric pressure as shown in Japanese Patent No. 3,554,312.

An upper part of the spacer 12 is bonded to a metal back 16 at a side of the anode substrate 11, and furthermore a lower part is connected onto the scan line 51 or the signal line 41 at a side of the cathode substrate 11. Here, FIG. 1 is a view showing a case that the spacer is bonded onto the scan line 51. When the FED panel is driven, since the upper part of the spacer 12 is applied with high voltage, and the lower part of the spacer 12 is applied with scan voltage or signal voltage, voltage difference occurs between the upper part and the lower part of the spacer 12.

On the other hand, in a vacuum, a uniform electric field from the anode substrate 15 to the cathode substrate 11 is produced by the high voltage applied to the anode substrate 11. The electrons 26 emitted from the electron emission elements 100 as above are accelerated to the phosphors 17 on the anode substrate 15 by the electric field. At that time, the spacer 12 needs to have conductivity for preventing charging of the spacer (refer to the Japanese Patent No. 3,554,312).

### SUMMARY OF THE INVENTION

In a configuration of the related art, power consumed by spacer current 27 is unnecessary, consumed power that does not contribute to image display. Furthermore, trouble of heating the panel due to Joule heat caused by the spacer current 27 may occur.

It is desirable to provide an image display device that is reduced in power consumption by decreasing spacer current.

According to an embodiment of the present invention, there is provided an image display device which has a video signal detection circuit for performing detection of a feature of an inputted video signal, and is reduced in spacer current by decreasing high voltage when a result of the detection meets a predetermined condition.

Moreover, at least one of average amplitude of the video signal, maximum amplitude of the video signal, and a vertical synchronizing signal, which are features of the video signal, may be detected.

Moreover, when the average amplitude of the inputted video signal has a value that is equal to a threshold value or lower, output voltage of a high-voltage control circuit may be modified.

Moreover, when the maximum amplitude of the inputted video signal has a value that is equal to a threshold value or lower, the output voltage of the high-voltage control circuit may be modified.

Moreover, the output voltage of the high-voltage control circuit may be modified during a vertical retrace period.

Moreover, control may be performed such that the output voltage of the high-voltage control circuit is decreased to have an optional, fixed value according to the detection result, or decreased in proportional to the detection result, or decreased stepwise according to the detection result.

According to the embodiment of the present invention, an image display device that is reduced in power consumption by decreasing the spacer current can be realized.

### BRIEF DESCRIPTION OF THE DRAWINGS

FIG. 1 is a cross section view of an FED panel for illustrating the related art;

FIG. 2 is a view showing a structure of a display panel of an image display device according to an embodiment of the present invention;

FIG. 3 is a circuit block diagram for illustrating a first embodiment of the present invention;

FIG. 4 is a circuit block diagram for illustrating a video signal detection circuit of the first embodiment of the present invention;

FIG. 5 is a voltage waveform diagram showing an example of a voltage waveform of a high-voltage value which is controlled according to the first embodiment of the present invention;

FIG. 6 is a voltage waveform diagram showing an example of a voltage waveform of a high-voltage value which is controlled according to the first embodiment of the present invention;

FIG. 7 is a voltage waveform diagram showing an example of a voltage waveform of a high-voltage value which is controlled according to the first embodiment of the present invention;

FIG. 8 is a circuit block diagram for illustrating a video signal detection circuit of a second embodiment of the present invention;

FIG. 9 is a voltage waveform diagram showing an example of a voltage waveform of a high-voltage value which is controlled according to the second embodiment of the present invention;

FIG. 10 is a circuit block diagram for illustrating a third embodiment of the present invention;

FIG. 11 is a circuit block diagram for illustrating a video signal detection circuit of the third embodiment of the present invention;

FIG. 12 is a voltage waveform diagram showing an example of a voltage waveform of a high-voltage value which is controlled according to the third embodiment of the present invention;

FIG. 13 is a circuit block diagram for illustrating a fourth embodiment of the present invention; and

FIG. 14 is a circuit block diagram for illustrating a video signal detection circuit of the fourth embodiment of the present invention, and a voltage waveform diagram showing an example of a voltage waveform of a high-voltage value which is controlled according to the fourth embodiment.

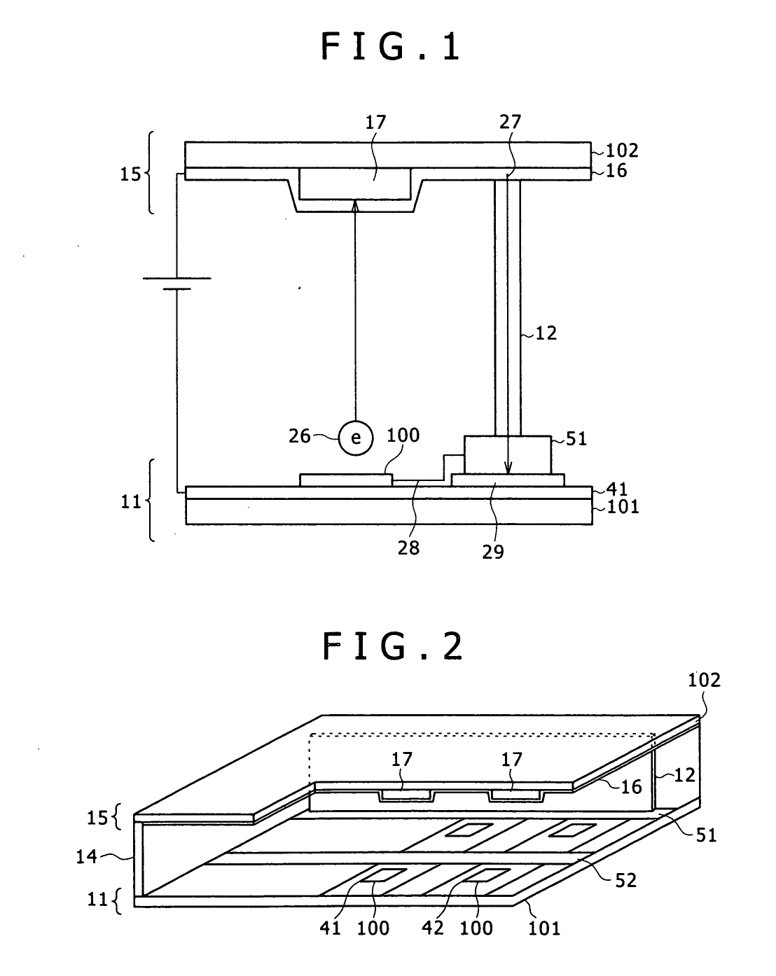

### DETAILED DESCRIPTION OF THE PREFERRED EMBODIMENT

Hereinafter, embodiments of the present invention will be described with reference to drawings.

### Embodiment 1

In this embodiment, a description is made using the passive-matrix-drive FED as an example, which has MIM (Metal-Insulator-Metal) electron sources as the electron emission elements. However, embodiments of the present invention can be applied similarly to an FED having electron sources other than the MIM electron sources, for example, SCE (surface conduction electron-emitter) or carbon-nano-tube electron sources.

FIG. 2 is a cross section view of an FED display panel. A structure of the display panel is described using FIG. 2. The display panel includes a cathode substrate 11, an anode substrate 15, and a spacer 12, and flit glass 14.

A space is formed between the cathode substrate 11 and the anode substrate 15, which is evacuated into a vacuum atmosphere. The circumference of the cathode substrate 11 and the anode substrate 15 is sealed by the flit glass 14 for vacuum lock.

The spacer 12 is disposed for bearing the atmospheric pressure applied to the display panel. One end of the spacer is bonded to a metal back 16 configuring the anode substrate 15, which is described later, in addition, the other end is bonded onto the scan line. Here, while the other end of the spacer 12 is bonded onto the scan line in FIG. 2, a structure where it is bonded onto the signal line may be used.

The cathode substrate 11 includes a transparent glass substrate 101, scan lines 51 to 52, signal lines 41 to 42, and electron emission elements 100. On the transparent glass substrate 101, plural scan lines 51 to 52 formed extending in a horizontal direction on a screen (lateral direction on a sheet) are disposed in rows in the vertical direction on the screen (longitudinal direction on the sheet). Furthermore, plural signal lines 41 to 42 formed extending in the vertical direction of the screen (longitudinal direction on the sheet) are disposed in rows in the horizontal direction on the screen (lateral direction on the sheet). The scan lines 51 to 52 and the signal lines 41 to 42 are perpendicular to each other, and an electron emission element 100 connected to each of the scan lines and each of the signal lines is disposed near an intersection of them. Thus, plural electron emission elements 100 are configured to be disposed in a matrix pattern. Here, while two lines are provided for the signal lines and the scan lines respectively for simplifying representation in FIG. 2, actually the number is larger than two in both the signal lines and the scan lines.

The anode substrate 15 is disposed facing the cathode substrate 11, and includes the transparent glass substrate 102, metal back 16, and phosphors 17.

The phosphors 17 are disposed in positions opposed to positions of respective electron emission elements 100. Moreover, the metal back 16 applied with high voltage is formed on the phosphors 17. Electrons emitted from the electron emission elements are accelerated by the high voltage applied to the metal back 16, and advances in the vacuum, causing luminescence of the phosphors due to excitation. Light of the luminescence is emitted to the outside through the transparent glass substrate 102, consequently images are formed on a screen of the FED. Here, a value of the high voltage applied to the metal back 16 is desirably about 10 kV.

On the other hand, the high voltage is applied to the metal back 16, thereby high voltage of about 10 kV is applied to an upper end of the spacer 12. A resistance value of the spacer 12 is set to about 1×10⁷ to 1×10¹⁰Ω to prevent disturbance in an electric field due to charging. Therefore, spacer current of about 1 to 1000 μA is flown for a sheet of spacer, which is applied to the metal back. The spacer current can be controlled by the high voltage value applied to the metal back 16.

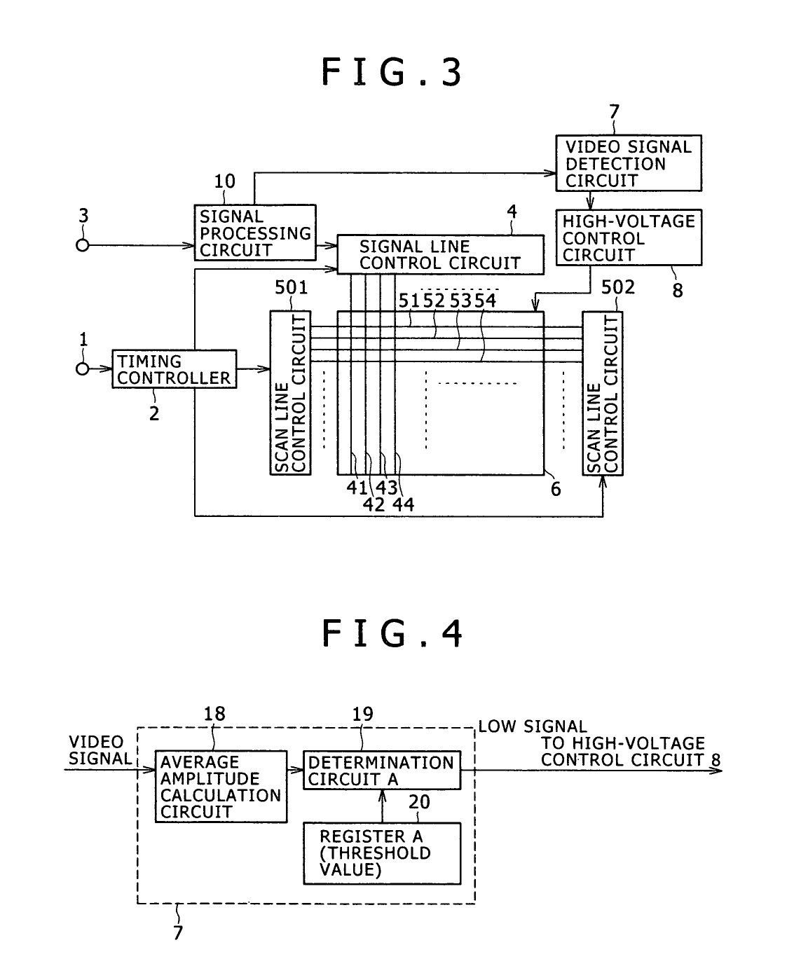

Next, a configuration example of a circuit block of an image display device to which the embodiment of the present invention is applied is described using FIG. 3. FIG. 3 is a view showing a configuration example of a circuit block diagram in a first embodiment of the present invention.

A video signal is inputted into a video signal input terminal 3, and then supplied to a signal processing circuit 10. The signal processing circuit 10 performs various kinds of predetermined signal processing such as γ-correction, color correction, and contrast correction to the video signal. A video signal generated therethrough is inputted into a signal line control circuit 4 and a video signal detection circuit 7.

On the other hand, a synchronizing signal corresponding to the inputted video signal is inputted into a synchronizing signal input terminal 1, and then supplied to a timing controller 2. The timing controller 2 generates timing pulses corresponding to a horizontal synchronizing signal and a vertical synchronizing signal, and then outputs the pulses to scan line control circuits 501, 502 and a signal line control circuit 4.

The video signal detection circuit 7 detects average amplitude and/or maximum amplitude of the inputted video signal. A detection result of the video signal detection circuit 7 is inputted into a high-voltage control circuit 8. The high-voltage control circuit 8 controls the high voltage applied to the metal back of a display panel 6 according to the detection result of the video signal detection circuit 7.

Here, while the scan-line control circuits are disposed at left and right, two ends of the scan lines in FIG. 3, a structure where the scan-line control circuit is disposed only at one side may be used. Moreover, while the signal line control circuit is disposed only at upper ends of the signal lines, a configuration where two signal line control circuits are disposed at both ends may be used.

Scan lines 51 to 54 in FIG. 3 are connected with the scan-line control circuits 501 and 502. The scan-line control circuits 501 and 502 supply scan voltage for selecting one or two scan lines from the scan lines 51 to 54 in synchronization with the timing pulses from the timing controller 2 respectively. That is, the scan-line control circuits 501 and 502 sequentially apply horizontal synchronizing scan voltage to the scan lines 51 to 54, thereby perform vertical scan by selecting one or two rows of electron sources in order from the top in a horizontal cycle.

Upper ends of the signal lines 41 to 44 are connected with the signal line control circuit 4 that is a signal voltage supply circuit. The signal line control circuit 4 generates signal voltage corresponding to each of signal lines (electron emission elements) based on the video signal supplied from the signal processing circuit 10 and then supplies the voltage to each of the signal lines.

When the signal voltage from the signal line control circuit 4 is applied to each of the electron emission elements connected to the scan line selected by the scan voltage, a potential difference between the scan voltage and drive voltage is given to each of the electron emission elements. When the potential difference exceeds a certain threshold value, the electron source emits electrons. The amount of electron emission from the electron source is approximately in proportional to the potential difference when the potential difference has a value that is equal to a threshold value or more. When the signal voltage is positive, the scan voltage is negative; and when drive voltage is negative, the scan voltage is positive.

In the embodiment of the present invention, according to the above method, electrons are emitted from respective electron sources disposed near respective intersections of the scan lines 51 to 52 and the signal lines 41 to 42 perpendicular to each other to cause luminescence of the phosphor, thereby image display is performed based on the video signals supplied from the signal processing circuit 10.

Next, the video signal detection circuit, which is the most characteristic component of the embodiment of the present invention, for modifying output voltage of the high-voltage control circuit that controls voltage between both ends of the spacer is described in detail using FIG. 4.

FIG. 4 is a diagram showing a configuration of the video signal detection circuit 7 in the first embodiment of the present invention. The video signal from the signal processing circuit 10 is inputted into an average amplitude calculation circuit 18 configuring the video signal detection circuit 7. The average amplitude calculation circuit 18 calculates average amplitude of the inputted video signal, and outputs a calculation result to a determination circuit A19. The determination circuit A19 compares a threshold value stored in a register A20 to the calculation result, and when the calculation result has a value that is lower than the threshold value, the circuit outputs a signal (Low signal) for performing control of decreasing the high voltage value to the high-voltage control circuit 8 in FIG. 3. When the Low signal is inputted into the high-voltage control circuit 8, control of decreasing the high voltage value to be applied is performed.

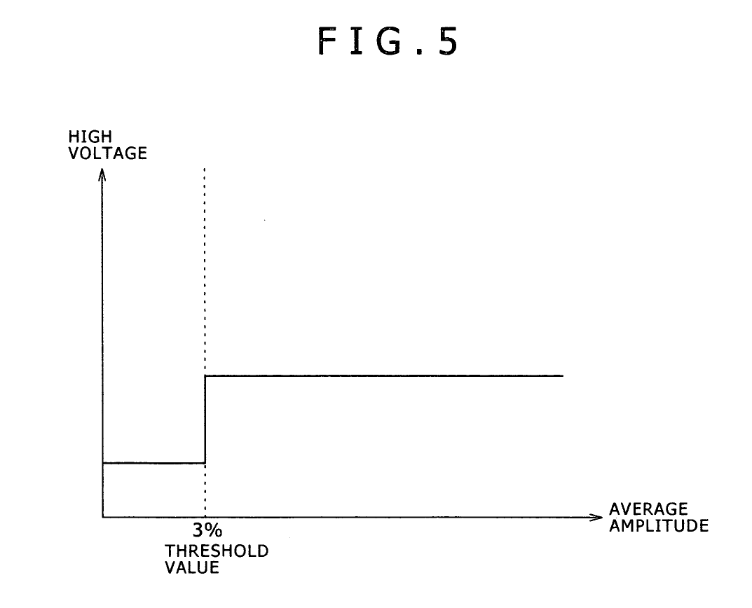

FIG. 5 is an example of a voltage waveform diagram of the high voltage value controlled by a method as described above, in which a horizontal axis shows the average amplitude and a vertical axis shows a high voltage value. FIG. 5 shows a waveform in the case that the threshold value for outputting the Low signal is assumed to have the average amplitude of, for example, 3%, and when the average amplitude has a value that is equal to the threshold value or lower, the control of decreasing the high voltage value is performed. It will be appreciated that if the threshold value is set to a value other than the value having the average amplitude of 3%, embodiments of the present invention are effective.

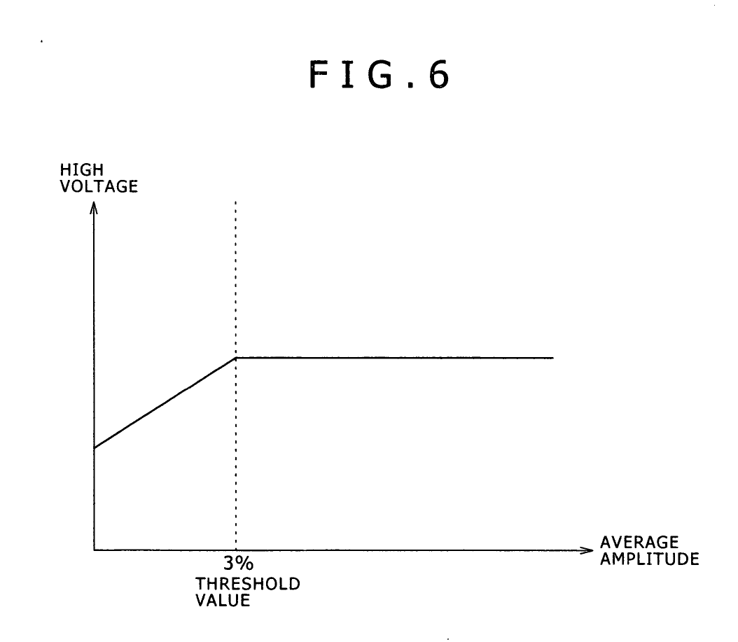

FIG. 6 is another example of the voltage waveform diagram of the high voltage value controlled by the method, in which a horizontal axis shows the average amplitude and a vertical axis shows a high voltage value. It is different from FIG. 5 in that when the average amplitude has a value that is equal to the threshold value or lower, control of modifying the high voltage value in proportional to the average amplitude is performed.

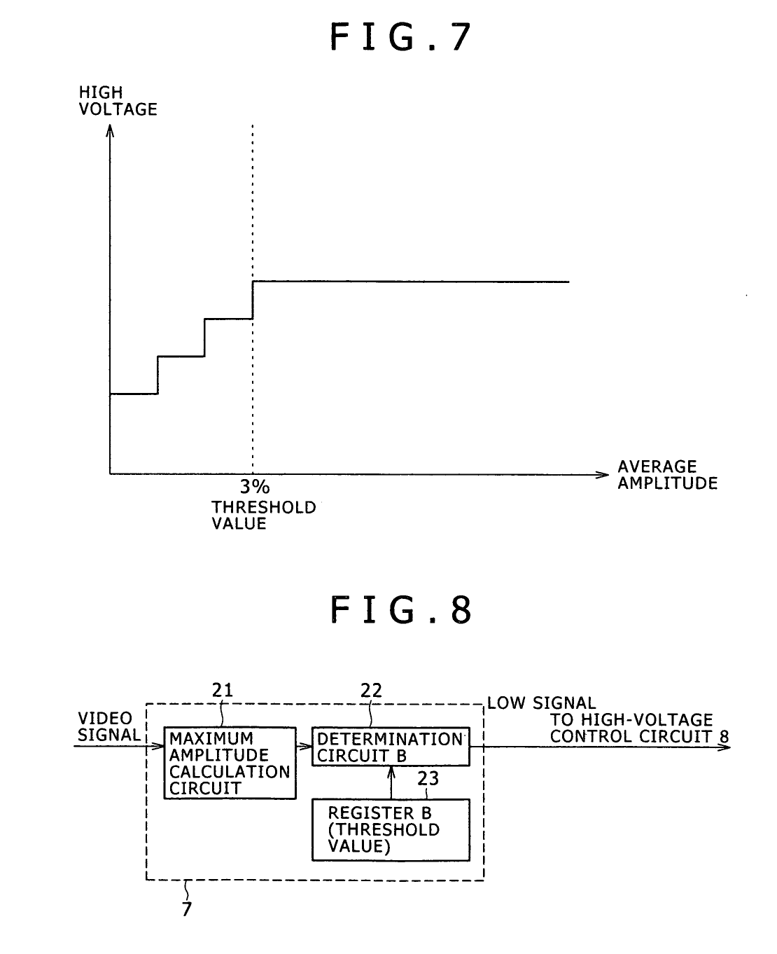

FIG. 7 is another example of the voltage waveform diagram of the high voltage value controlled by the method, in which a horizontal axis shows the average amplitude and a vertical axis shows a high voltage value. It is different from FIG. 5 and FIG. 6 in that when the average amplitude has a value that is equal to the threshold value or lower, the high voltage value is controlled stepwise according to the average amplitude. While FIG. 7 shows such an example that when the average amplitude has a value that is equal to the threshold value or lower, control is performed by using three stages of high voltage values, it will be appreciated that when control is performed in any optional number of stages of at least two stages, the present invention is effective.

As described hereinbefore, in the embodiment, when a video signal having a small average amplitude is inputted, control is performed such that the spacer current is decreased by decreasing the high voltage to control power consumption. Although luminance of a display image is reduced by decreasing the high voltage, the threshold value for control is appropriately set, thereby consistent, appropriate image display can be achieved. In particular, the control is performed only in the case of dark images, and thus comfortable display in which decrease in luminance is unnoticeable can be achieved.

### Embodiment 2

Next, a second embodiment of the present invention is described using FIG. 3 and FIG. 8.

The embodiment is approximately the same as the first embodiment, but different from the first embodiment in a configuration of the video signal detection circuit 7. FIG. 8 is a diagram showing the configuration of the video signal detection circuit 7 in the embodiment. The video signal from the signal processing circuit 10 is inputted into a maximum amplitude calculation circuit 21 configuring the video signal detection circuit 7. The maximum amplitude calculation circuit 21 calculates maximum amplitude of the inputted video signal, and outputs a calculation result to a determination circuit B22. The determination circuit B22 compares a threshold value stored in a register B23 to the calculation result, and when the calculation result has a value that is lower than the threshold value, the circuit outputs a signal (Low signal) for performing control of decreasing the high voltage value to the high-voltage control circuit 8 in FIG. 3. When the Low signal is inputted into the high-voltage control circuit 8, the circuit performs control of decreasing the high voltage value to be applied.

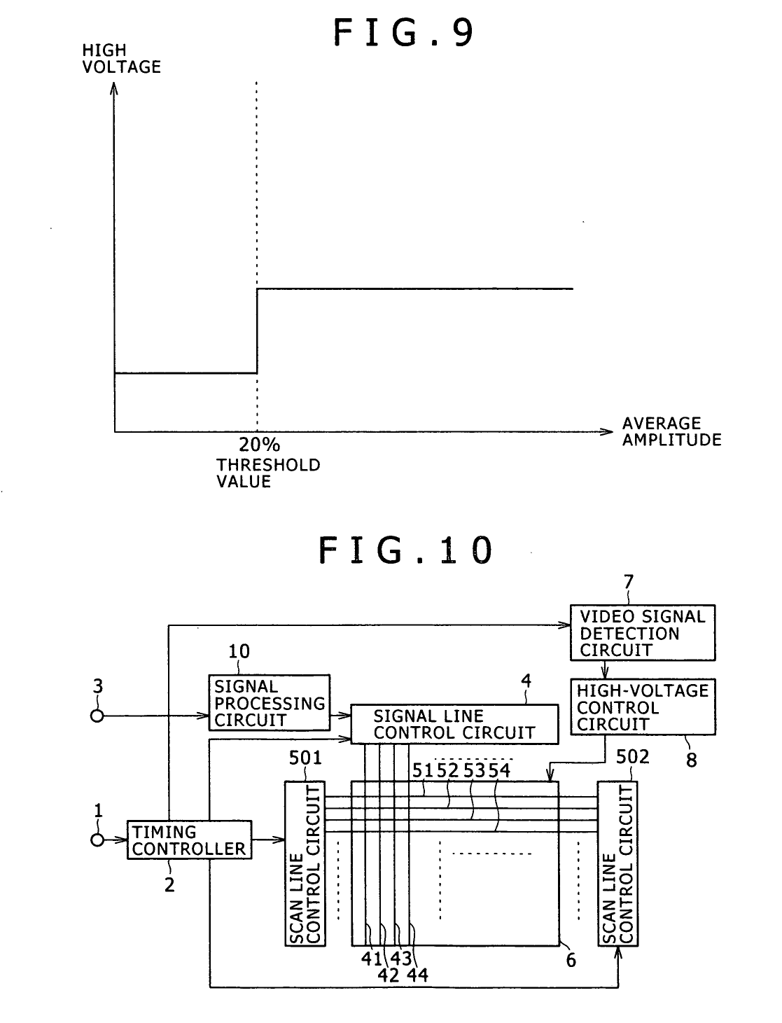

FIG. 9 is an example of a voltage waveform diagram of the high voltage value controlled by a method as described above, in which a horizontal axis shows the maximum amplitude and a vertical axis shows a high voltage value. FIG. 9 shows a waveform in the case that the threshold value for outputting the Low signal is assumed to have the maximum amplitude of 20%, and when the maximum amplitude has a value that is equal to the threshold value or lower, control of decreasing the high voltage value is performed. It will be appreciated that the present invention is effective even when the threshold value is set to a value other than the value having the maximum amplitude of 20%. Furthermore, the present invention is effective when the high voltage value is subjected to linear control and stepwise control as shown in FIG. 6 and FIG. 7 in the embodiment 1. As hereinbefore, when the maximum amplitude of the inputted video signal is smaller than the threshold value set in the register B 23, control is performed such that the spacer current is decreased by decreasing the high voltage value to control the power consumption.

### Embodiment 3

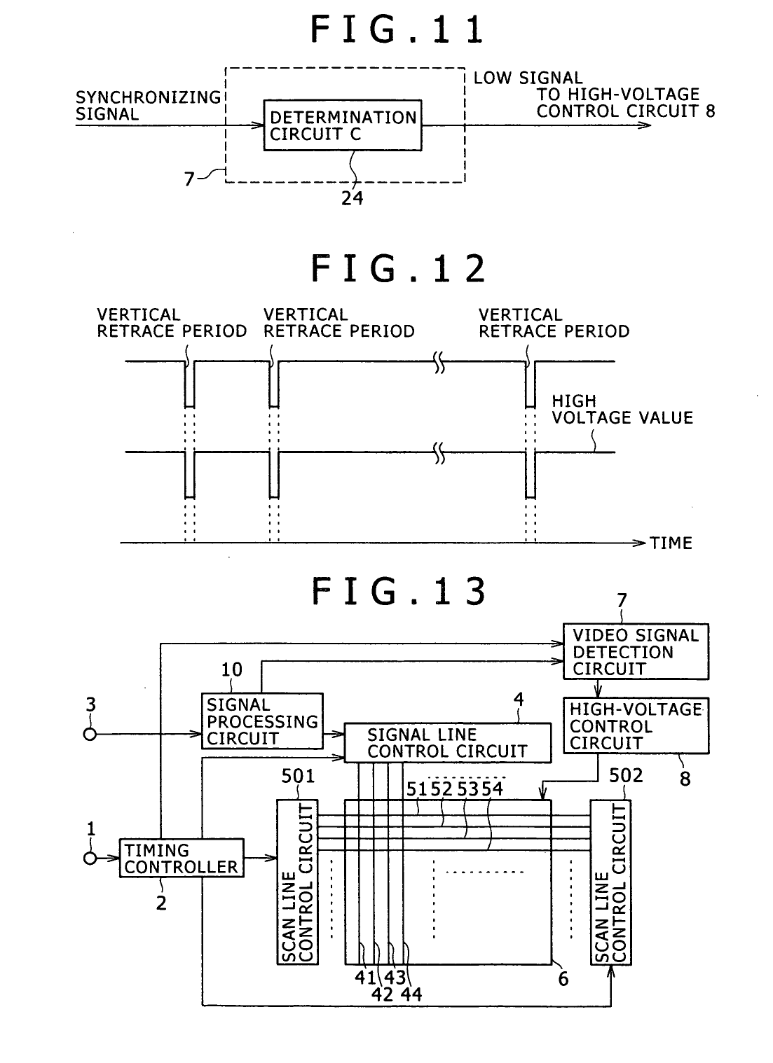

Next, a third embodiment of the present invention is described using FIG. 10 and FIG. 11.

FIG. 10 is a diagram showing a configuration example of a circuit block in the embodiment. FIG. 10 is different from FIG. 3 in that a timing pulse for the video signal is inputted from the timing controller 2 into the video signal detection circuit 7, but is the same as FIG. 3 in other points. In FIG. 10, components marked with the same signs as in FIG. 3 have the same functions.

FIG. 11 is a diagram showing a configuration of the video signal detection circuit 7 in the embodiment, and FIG. 12 is a timing chart diagram of the high voltage value controlled in the embodiment and a vertical retrace period. The timing pulse for the video signal outputted from the timing controller 2 is inputted into a determination circuit C24 configuring the video signal detection circuit 7. The determination circuit C24 determines the vertical retrace period from the inputted timing pulse, and outputs the Low signal to the high-voltage control circuit 8 in FIG. 10 during the vertical retrace period. When the Low signal is inputted into the high-voltage control circuit 8, control of decreasing the high voltage value to be applied is performed as shown in FIG. 12.

In this way, in the embodiment, control is performed such that the high voltage is decreased during the vertical retrace period where images are not displayed, and thus the spacer current is decreased to control power consumption. Here, since images are not displayed during the vertical retrace period, even if control of decreasing the high voltage to O V is performed, the present invention is effective.

Here, for example, when a resistance value due to the spacer between the metal back and the scan line is 1×10⁷Ω and the high voltage value is 10 kV, total sum of current flowing into each spacer is 1 mA and consumed power at that time is 10 W. In the case that an NTSC video signal is inputted in the embodiment, when the high voltage is decreased to 0 V during the vertical retrace period, power consumption due to the spacer current is about 9.1 W, consequently power consumption can be reduced about 8.6%.

### Embodiment 4

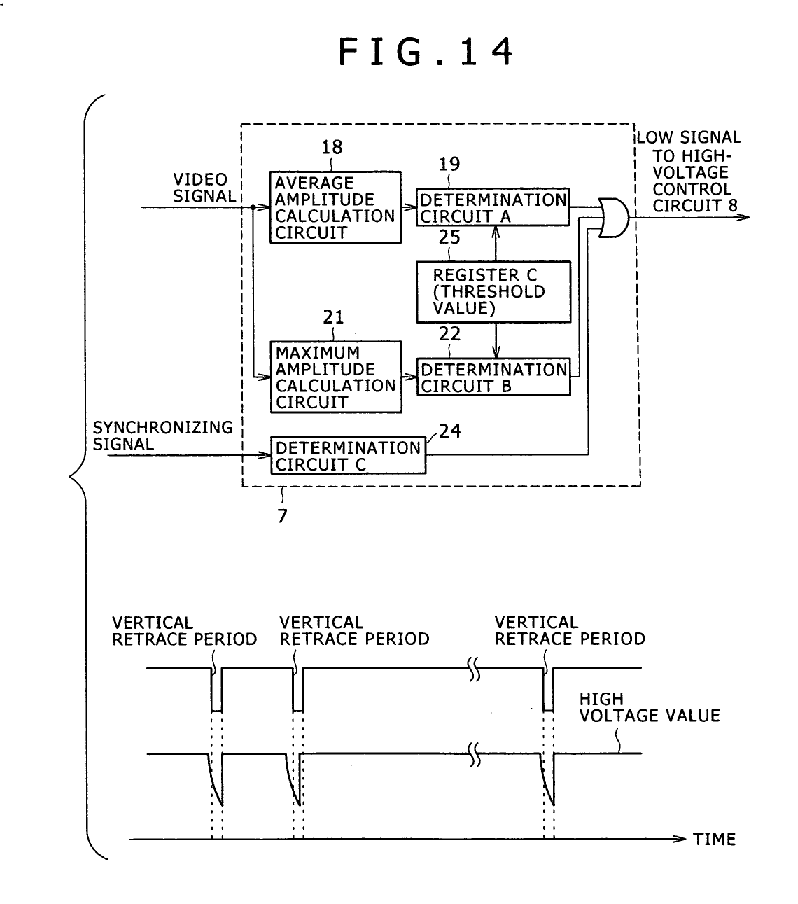

Next, a fourth embodiment of the present invention is described using FIG. 13 and FIG. 14.

FIG. 13 is a diagram showing a configuration example of a circuit block in the embodiment. FIG. 13 is different from FIG. 3 and FIG. 10 in that both the timing pulse and the video signal are inputted into the video signal detection circuit 7, but is the same in other points. In FIG. 13, components marked with the same signs as in FIG. 3 and FIG. 10 have the same functions.

FIG. 14 is a diagram showing a configuration of the video signal detection circuit 7 in the embodiment. The video signal detection circuit 7 in the embodiment has a configuration where the control described in the embodiment 1, embodiment 2 and embodiment 3 can be concurrently carried out. In FIG. 14, components marked with the same signs as in FIG. 4, FIG. 8 and FIG. 11 have the same functions.

During an image display period (period except for the vertical retrace period), the video signal from the signal processing circuit 10 is inputted into the average amplitude calculation circuit 18 and the maximum amplitude calculation circuit configuring the video signal detection circuit 7. The average amplitude calculation circuit 18 calculates the average amplitude of the inputted video signal, and outputs a calculation result to the determination circuit A19. The determination circuit A19 compares a threshold value stored in a register C25 to the calculation result, and when the calculation result has a value that is lower than the threshold value, the circuit outputs the signal (Low signal) for performing the control of decreasing the high voltage value to the high-voltage control circuit 8 in FIG. 13. On the other hand, the maximum amplitude calculation circuit 21 calculates the maximum amplitude of the inputted video signal, and outputs a calculation result to the determination circuit B22. The determination circuit B22 compares a threshold value stored in a register C25 to the calculation result, and when the calculation result has a value that is lower than the threshold value, the circuit outputs the Low signal to the high-voltage control circuit 8 in FIG. 13. Furthermore, during the vertical retrace period, the timing pulse outputted from the timing controller 2 is inputted into the determination circuit C24 configuring the video signal detection circuit 7. The determination circuit C24 determines the vertical retrace period from the inputted timing pulse, and outputs the Low signal to the high-voltage control circuit 8 in FIG. 13.

That is, the embodiment is a combination of the embodiments 1, 2 and 3, in which in the image display period, when a video signal having either the average amplitude or the maximum amplitude, the value of which is lower than the threshold value, is inputted, the high voltage is decreased, and even in the vertical retrace period, control of decreasing the spacer current by decreasing the high voltage is performed.

Here, while the embodiment is in a configuration where the average amplitude, maximum amplitude and vertical retrace period are determined to control the high voltage, the present invention is effective even in a combination of any two of them.

What is claimed is:

1. An image display device comprising;
a cathode plate on which a plurality of electron emission elements for emitting electrons are provided,
an anode plate having a plurality of phosphors, the plate being disposed facing the cathode plate,
spacers for holding a space between the cathode plate and the anode plate at a predetermined interval,
a high-voltage control circuit for controlling voltage between respective two ends of the spacers, and
a video signal detection circuit for detecting a feature of an inputted video signal;
wherein output voltage of the high-voltage control circuit is modified according to a detection result of the video signal detection circuit.

2. The image display device according to claim 1, wherein the video signal detection circuit detects at least one of average amplitude of the video signal, maximum amplitude of the video signal, and a vertical synchronizing signal, which are features of the inputted video signal.

3. The image display device according to claim 1, wherein the output voltage of the high-voltage control circuit is modified when the average amplitude of the inputted video signal has a value that is equal to a threshold value or lower.

4. The image display device according to claim 1, wherein the output voltage of the high-voltage control circuit is modified when the maximum amplitude of the inputted video signal has a value that is equal to a threshold value or lower.

5. The image display device according to claim 1, wherein the output voltage of the high-voltage control circuit is modified during a vertical retrace period of the video signal.

6. The image display device according to claim 1, wherein control is performed such that the output voltage of the high-voltage control circuit is decreased to an optional fixed value according to the detection result, or decreased in proportional to the detection result, or decreased stepwise according to the detection result.
